(19) United States
(12) Patent Application Publication
(10) Pub. No.: US 2004/0236017 A1
(43) Pub. Date: Nov. 25, 2004

(54) Method for the production of grafted copolymers made of starch, tert-alkylazocyanocarboxylic acid esters and grafted copolymers and the use thereof

(76) Inventors: Stefano Bruzzano, Potsdam (DE); Nathalie Sieverling, Berlin (DE); Werner Jaeger, Kleinmachnow (DE); Alireza Haji Begli, Ramsen (DE)

Correspondence Address: Barnes & Thornburg, 11 South Meridian Street, Indianapolis, IN, 46204, US

(21) Appl. No.: 10/484,002

(22) PCT Filed: Jul. 15, 2002
(86) PCT No.: PCT/EP02/07829

(30) Foreign Application Priority Data
Jul. 16, 2001 (DE) 101 34 560.7

(51) Int. Cl. C08F 2/00

(52) U.S. Cl. 525/54.31

(57) ABSTRACT

The invention relates to a method for the production of grafted copolymers with a skeleton formed from starch or the derivatives thereof. Production occurs by means of tert-alkylazocyanocarboxylic acid esters of starch which are coupled by radical reaction with vinyl monomers. The invention also relates to grafted copolymers of starch, the dispersions thereof and the use of said grafted copolymers.

A method for manufacturing graft copolymers from starch, tert-alkylazo cyano carboxylic acid ester as well as graft copolymers and their use.

The invention relates to a method for manufacturing graft copolymers with a backbone formed of starch and/or its derivatives. At the same time the manufacture is effected via tert-alkyl azocyano carboxylic acid esters of starch which are linked to vinyl monomers by way of a radical reaction. The invention likewise relates to graft copolymers of starch, their dispersions as well as to the use of graft copolymers.

Starch is a much-used natural polymer which may be easily obtained on a large scale. Starch in its natural form has found many applications in the technical field as well as in the foodstuff industry. This comprehensive application potential may be broadened and optimised by way of a modification of the starch molecules.

The modification of starch may e.g. be effected by the usual reactions of organic chemistry. With this however to some part only unsatisfactory improvements in the desired application properties have been achieved. A rational variant is the combination of starch molecules with synthetic polymers, wherein the synthetic polymers are bonded to the starch molecule as a backbone in a covalent and comb-like manner. These graft copolymers of starch are e.g. known from G. F. Fanta et al. in: Encyclopaedia of Polymer Science and Technology, Suppl. Vol 2, 665-699 and G. F. Fanta in Block and Graft Copolymerization, Vol. 1, 665-699. These are generally obtained in that radicals are produced on the starch molecules which then trigger the polymerisation of vinyl monomers.

The production of the radicals may be effected chemically as well as physically. The physical radical formation by α-, β- or UV radiation is quite unspecific and generally leads to the formation of considerable constituent [parts] of homopolymers of the vinyl monomers used for grafting. The radicals on the starch molecules are produced chemically by redox reactions. Cerium and manganese salts are often applied as oxidants. Moreover redox systems are recommended from which firstly low-molecular radicals, e.g. hydroxyl radicals arise. These transmit their radical properties to the starch. Examples of this are permanganates in the presence of acids, persulphates or the system hydrogen peroxide/iron-II salts.

With these methods of chemically producing the starch radicals to some extent considerable quantities of homopolymers are also formed so that here too an undefined mixture of graft copolymers, homopolymers and unmodified starch is present.

It is furthermore disadvantageous that with the use of salts of heavy metals, the metal ions are difficult to remove from the end products, and that here the reactions also run in a very unspecific manner so that one may not create any tailor-made products.

A further initiation type lies in the introduction of thermally cleavable [seaparable] groups into the starch molecule. It is based on the fact that the starch molecule in a primary chemical reaction is firstly converted with a low-molecular compound which contains a thermally cleavable [separable] group. The peroxy and azo groups are counted amongst the thermally cleavable groups. The manufacture of starch containing azo groups is described in DE 3430676 A1 and in EP 0173517 A2. The manufacture is effected by converting starch with the di-acid chloride of an azo-dicarboxylic acid. This method however has the disadvantage that the conversion is not effected completely. By way of this, low-molecular initiator radicals are also formed with the thermal activation, which leads to the formation of homopolymers.

A second variant lies in the production of aldehyde groups or keto[ne] groups in the starch which in a complicated sequence of three polymer-analogous conversions leads to an azo compound of the starch with which two anhydro-glucose units are linked via an azo-biscyano group. Here it is particularly disadvantageous that with a thermal activation the formed radicals very easily recombine and thus lead to the formation of denatured constituent parts.

Proceeding from this and the disadvantages of the state of the art which this entails, it is the object of the present invention to develop a method which permits the manufacture of graft copolymers which are free of homopolymers and may be applied to a broad spectrum of different vinyl monomers.

This object is achieved by the method with the features of claim 1. The object is further achieved by the tert-alkyl azocyano carboxylic acid esters with the features of claim 10 and the graft copolymers with the features of claim 14. claim 18 relates to a dispersion of the graft copolymer and claim 19 to the use, according to the invention, of the graft copolymers. The further dependent claims specify advantageous further formations.

According to the invention there is provided a method for the manufacture of graft copolymers with a backbone formed of starch and/or its derivatives, proceeding from amylose of the general Formula I

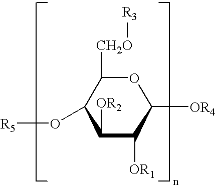

and/or from the amylopectine which is derived there-from. With this R₁ to R₅ independently of one another indicate H, SO₃Na, PO(ONa)₂, NO₂, C(S)—SNa, alkyl or acyl with 1-20 C-atoms or aryl, which may be cationically, anionically, hydrophobically and/or amphiphilically substituted. The group R₃ may also be selected such that with this a linking to further glucose units is effected whilst forming an amylopectine. With this it is the case of a classic 1,6 bonding which leads to the branch-like amylopectine after an average of 25 glucose building blocks. The number of structure units n may lie between 300 and 60,000. The method is then effected via the following steps:

a) conversion of the starch with the described structure in the presence of an acid acceptor with the general Formula II

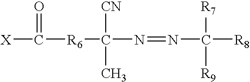

With this R6 may represent an alkyl group or a carboxyalkyl group with 1-20 C-atoms. R₇, R₈ und R₉ independently of one another are alkyl groups, straight-chained or branched, with 1-6 C-atoms or a phenyl group. The group X in the general Formula II may represent a halogen as well as a group ROO— forming an anhydride, wherein the residue R may represent any alkyl-, aryl- or arylalkyl group.

b) in the following step the addition of at least one vinyl monomer is the effected

c) finally the initiation of the polymerisation is effected by the formation of starch radicals via a thermal activation between 25 and 120° C. With this, a separation of nitrogen occurs. At the same time two radicals are formed, a reactive macro-radical which triggers the radical polymerisation of the vinyl monomers, and a non-reactive tert-alkyl radical which is inactive given polymerisation.

Starch as well as its derivatives may be used as a starting compound for the method according to the invention. Physically as well as chemically modified derivatives are counted amongst the derivatives. Hydrolysed, ionic, hydrophobic or also amphiphilic derivatives are counted amongst the chemically modified derivatives.

The method may be carried out in various media. In a first variant the conversion of the tert-alkyl-azocyano carboxylic acid derivative may be carried out in an aqueous or organic solvent, wherein the starch is present in dissolved form.

A further alternative is represented by the conversion in a) as a solid-phase reaction. With this one may completely do away with the application of a solvent. One only requires and intensive intermixing of the reaction partners.

As a third variant, the conversion in a) may also be carried out in an aqueous suspension. The conversion is then effected on the starch particles present in the suspension.

Preferably tert-alkyl azocyano carboxylic acid chloride or also a mixed anhydride of tert-alkyl azocyano carboxylic acid with a further acid, particularly preferably succinic acid is applied in step a).

In a preferred embodiment, in step b) of the method, one applies monomers at least partly soluble in water. These may be ionic as well as anionic, amphotic or neutral. It is just as possible to use mixtures of vinyl monomers with these properties.

Derivatives of acrylic acid or methacrylic acid are particularly considered as cationic vinyl monomers. The quaternary esters or amides of these acids are particularly counted amongst these. Dialyl-dimethyl ammonium chloride may be used as a further cationic vinyl monomer.

Acrylic acid, methacrylic acids, vinyl sulphonic acids and/or styrene sulphonic acids are preferably applied.

Acrylamide, N-vinyl formamide, N-methyl-N-vinyl acetate amide, N-Vinyl pyrrolidone, and/or N-vinyl caprolactam are preferably applied as neutral vinyl monomers.

At the same time the vinyl monomers are preferably applied in a concentration between 0.1 und 4.0 mol/l and particularly preferred between 0.7 und 1.5 mol/l. The conversion at the same time may be carried out in aqueous as well as organic solvents.

According to the invention likewise tert-alkyl-azocyano carboxylic acid esters of starch and/or its derivatives are likewise prepared proceeding from amylose of the general Formula III

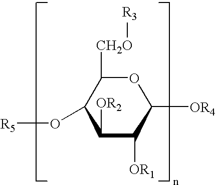

and/or the amylopectine deriving therefrom. With this R₁ to R₅ independently of one another may be selected from the group H, SO₃Na, PO(ONa)₂, NO₂, C(S)—SNa, alkyl or as acyl with 1-20 C-atoms, which may be substituted cationically, anionically, hydrophobically and/or amphiphilically. The group R₃ may also be selected such that via this a linking to further glucose units is effected whilst forming an amylopectine. With this it is the case of a classic 1,6 bonding which after an average of 25 glucose building blocks leads to the branch-like amylopectine molecule. In the whole amylose molecule and/or amylopectine molecule at least one of the residues R₁ to R₅ is present as a group with the general Formula IV

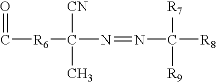

With this, R₆ represents an alkyl group or carboxyalkyl group with 1-20 C-atoms which may be interrupted by heteroatoms, as well as substituted. R₇, R₈ und R₉, independently of one another are an alkyl group, which may be straight-chained or branched with 1-6 C-atoms, or a phenyl group. The number of structure units n may lie between 300 and 60,000.

Preferably the residues R₁ to R₅ independently of one another may be selected from the group (alkyl)amino-alkyl, ammonium alkyl, carboxy-alkyl, alkyl, aryl, arylalkyl und hydroxyalkyl.

The molar mass of the tert-alkyl azocyano carboxylic acid ester preferably lies between 5000 and 10000000 g/mol and particularly preferred between 10000 and 5000000 g/mol.

The degree of substitution (DS-value) of the residues R₁to R₅ may lie between 0.00 und 0.9. The degree of substitution of the tert-alkyl azocyano carboxylic acid group of the general Formula IV may preferably lie between 0.01 und 0.9, wherein in both cases the degree of substitution may be set in a targeted manner by way of the method parameters.

According to the invention graft copolymers of starch and/or its derivatives are prepared proceeding from amylose of the general Formula III

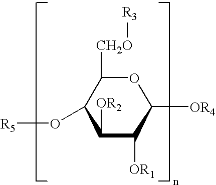

and/or the amylopectine deriving therefrom. With this, R₁ to R₅ independently of one another are selected from the group H, SO₃Na, PO(ONa)₂, NO₂, C(S)—SNa, alkyl or acyl with 1-20 C-atoms which may be substituted cationically, anionically, hydrophobically and/or amphiphilically. The group R₃ may also be selected such that by way of this a linking to further glucose units is effected whilst forming an amylopectine. With this it is the case of a classic 1,6 bonding which after an average of 25 glucose building blocks leads to the branch-like amylopectine. At least one of these residues in the whole amylose molecule and/or amylo-pectine molecule at the same time is a group of the general Formula V

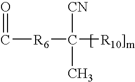

With this R₆ is an alkyl- or carboxyalky group with 1-20 C-atoms which may be interrupted by heteroatoms, as well as substituted. R₁₀ represents a vinyl monomer, wherein the repetition rate n lies between 10 und 10,000.

Preferably the residues R₁ to R₅ independently of one another are selected from the group (alkyl)amino-alkyl, ammonium alkyl, carboxy-alkyl, alkyl, aryl, arylalkyl, hydroxyalkyl, —CO—R and —CO—NHR, wherein R is selected from the group alkyl, aryl und arylalkyl.

The molar mass of the starch backbone chain preferably lies between 5000 und 10000000 g/mol and particularly preferred between 10000 and 5000000 g/mol.

The residues R₁ to R₅ may have a degree of substitution of between 0.00 und 0.9, wherein these may be set in a targeted manner by way of method parameters. The degree of substitution (DS-value) of the tert-alkyl azocyano carboxylic acid group may likewise be set in a targeted manner and lies between 0.01 and 0.9.

The polymerisation may also be carried out with largely or completely water-insoluble monomers in water as a carrier phase. At the same time the monomer is firstly finely distributed in the usual manner in the presence of the tert-alkyl azocyano carboxylic acid ester. The initiation of the polymerisation is subsequently effected by way of thermal activation, wherein temperatures between 30 and 90° are preferred. Stable dispersions of the polymerised vinyl monomer are obtained without the further addition of an emulsifier. At the same time the particle size may be set in the region between 80 and 800 nm, preferably between 100 and 300 nm by way of the selection of the concentration of the reaction partners. This targeted setting of the particle size may alternatively be encouraged by the addition of small quantities of a common emulsifier. At the same time a broad spectrum of unsaturated compounds may be applied individually or in combination. Preferably styrene, methyl styrene and butadiene count amongst these. Acrylates may likewise be used.

The graft copolymers have significantly improved application possibilities in many fields of application. Graft copolymers, which are manufactured with cationic vinyl monomers, are excellent flocculants with the separation of suspended solid matter and aqueous systems. With the same quantity of application, within a short time considerably improved precipitation, measured against the example of residual turbidity was achieved than with the application of conventional cationic starch.

### EXAMPLE 1

5.0 g of dry substance of waxy maize starch hydrolysate St⁹⁰⁰ (M_{AGE}=162.1 g/mol; 30 mmol, M_{W}=900000 g/mol) was dissolved in 100 ml dimethyl-acetamide (DMA) and heated to approx. 170° C. in order to distil off 30 ml of DMA under a N₂-flow.

One allows the solution to cool to room temperature and fills it into a 150 ml double casing reactor. Whilst stirring one adds a mixture of 3.64 g of triethyl amine (M=101.2 g/mol, 0.036 mol) and 10 ml of DMA.

The solution is subsequently cooled to 8° C. and 1.20 g of 4-tert.-butylazo-4-cyano valeric acid chloride t-BACVSC (M=229.7 g/mol; 5.2 mmol) was slowly added dropwise into 10 ml of DMA.

The reaction mixture was stirred at 8° C. for 24 h. The starch derivative was subsequently precipitated in 1 l of methanol, this in turn was taken up in water and dialysed for several days at 4° C. Starch ester with a DS of 0.05 was obtained from the freeze-drying.

The DS may be set in a targeted manner by varying the trial parameters (Table 1).

TABLE 1

| No. | t-BACVSC | TEA | St⁹⁰⁰ | DS |
|---|---|---|---|---|
| 1 | 0.040 mol | 0.070 mol | 0.030 mol | 0.72 |
| 2 | 0.010 mol | 0.100 mol | 0.030 mol | 0.05 |
| 3 | 0.010 mol | 0.070 mol | 0.060 mol | 0.04 |
| 4 | 0.025 mol | 0.085 mol | 0.030 mol | 0.14 |
| 5 | 0.025 mol | 0.070 mol | 0.045 mol | 0.13 |
| 6 | 0.010 mol | 0.085 mol | 0.045 mol | 0.04 |
| 7 | 0.020 mol | 0.080 mol | 0.040 mol | 0.10 |
| 8 | 0.030 mol | 0.075 mol | 0.035 mol | 0.60 |
| 9 | 0.015 mol | 0.090 mol | 0.035 mol | 0.07 |
| 10 | 0.005 mol | 0.036 mol | 0.031 mol | 0.05 |

### EXAMPLE 2

5.27 g of dry substance of trimethyl ammonium propyl starch ether St⁺ (M_{AGE}=175.7 g/mol; 30 mmol, DS 0.1, M_{W}=700000 g/mol) was dissolved in 100 ml of dimethyl acetamide (DMA) and heated to approx. 170° C., in order to distil off 30 ml of DMA under an N₂-flow.

The solution is allowed to cool to room temperature, the gel particles are filtered off, and filled it into a 150 ml double casing reactor. A mixture of 3.64 g of triethyl amine (M=101.2 g/mol, 0.036 mol) and 10 ml DMA are added whilst stirring.

Thereafter the solution is cooled to 8° C. and 1.20 g of 4-tert.-butylazo-4-cyano valeric acid chloride t-BACVSC (M=229.7 g/mol; 5.2 mmol) is slowly added drop-wise into 10 ml DMA.

The reaction mixture is stirred for 24 h at 8° C. The starch derivative is subsequently filled directly into dialysis flexible tubing and dialysed for water at 4° C. for several days. Starch ester with a DS of 0.05 was obtained from the freeze-drying.

### EXAMPLE 3

60.0 g TS of benzyl starch (M=173.7 g/mol, 0.35 mol DS 0.1, M_{W}˜10000 g/mol) und 0.50 g of dimethylbenzyl tridecyl ammonium chloride were suspended in 400 ml H₂O at room temperature and set to pH 8 with 1N NaOH. In a portioned manner 43.4 g of t-butyl azocyano propyl succinic acid anhydride (M=251 g/mol, 0.173 mol) was subsequently suspended amid stirring at a constant pH value of B. Die pH-control is effected by way of continuously metering a sodium hydroxide solution. The gel-like, water-insoluble constituent parts were centrifuged away after 24 h reaction time and the supernatant solution was dialysed for water. By way of freeze-drying one obtains a benzyl starch semi-ester of t-butyl-azocyano propyl succinic acid with a DS=0.05.

### EXAMPLE 4

5.00 g of dried waxy maize starch hydrolysate St³⁰⁰ (M_{AGE}=162.1 g/mol; 31 mmol, M_{W}=300000 g/mol), 3.64 g triethyl amine (M=101.2 g/mol) und 1.20 g 4-tert.-butylazo-4-cyano valeric acid chloride (M=229.7 g/mol; 5.22 mmol) was slurried in 30 ml of dried diethyl-ether whilst stirring. Ether was drawn off at 30° C. amid continuous stirring in a low vacuum (200 mbar). The residue was stored at 4° C. for 14 days. The residue was subsequently taken up in water and dialysed for several days at 4° C. Starch ester with a DS of 0.01 was obtained from the freeze-drying.

The homogenisation of the reaction mixture may be effected with the application of a kneading device capable of being thermostatted, also without the application of ether.

### EXAMPLE 5

7.56 g of a 75% aqueous solution of methacryloyl-oxyethyl-dimethylbenzyl ammonium chloride MADAM-BQ (M=283.4 g/mol) und 3.44 g 4-tert.-butylazo-4-cyano valeric acid ester of a waxy maize starch hydrolysate t-BACVS-St⁶³⁷ (M_{W}=637000 g/mol) (M=171.8 g/mol) were filled with distilled water to 200 ml. The solution is filled into an double casing reactor capable of being thermostatted and controlled with with regard to its inner temperature, with an anchor agitator, backflow cooler, temperature probe (Pt 100) and gas introduction tube. The apparatus is then subsequently thoroughly rinsed at 10° C. for several hours whilst stirring with a low argon flow. After 180 minutes the solution is diluted with 100 ml of a cold 1% aqueous hydroquinone solution, filled into dialysis flexible tubing and dialysed for several days for water. Pure graft copolymer was obtained from the freeze-drying.

The concentration of monomer MADAM-BQ C_{M} and the concentration of the starch ester t-BACVS-St⁶³⁷ c_{t-BACVS-St} as well as its degree of substitution DS (0.01 to 0.15 water-soluble) was varied as described in the following tables. The obtained variables of conversion and mass constituent part of bonded poly-MADAM-BQ are specified in the Tables 2, 3, 4. No formation of homopolymer P-MADAM-BQ was observed during the graft polymerisation.

TABLE 2
variation of the initiator concentration
C_{t-BACVS-St} (DS = 0.05, C_{M} = 0.1 M)

| | | conversion | |
|---|---|---|---|
| No. | C_{t-BACVS-St} [M] | [%] | w [%] |
| 1 | 0.10 | 84 | 58 |
| 2 | 0.20 | 89 | 48 |
| 3 | 0.30 | 89 | 45 |
| 4 | 0.40 | 83 | 32 |

TABLE 3
variation of the DS (C_{M} = 0.1 M)

| | | | conversion | |
|---|---|---|---|---|
| No. | DS | C_{t-BACVS-St} [M] | [%] | w [%] |
| 5 | 0.05 | 0.20 | 89 | 48 |
| 6 | 0.10 | 0.10 | 93 | 57 |

TABLE 4
variation of the monomer concentration
C_{M} (DS = 0.05, C_{t-BACVS-St} = 0.25 M)

| | | Conversion | |
|---|---|---|---|
| Nr. | C_{M} [M] | [%] | w [%] |
| 7 | 0.05 | 56 | 16 |
| 8 | 0.10 | 85 | 47 |
| 9 | 0.15 | 92 | 61 |
| 10 | 0.20 | 95 | 66 |

Analogous polymerisations may be carried out in dimethyl acetamide. The application of higher substituted t-BACVS-St⁶³⁷ with DS up to 0.9 is possible by way of this.

### EXAMPLE 6

A double casing autoclave controlled with respect to its inner temperature and capable of being thermostatted, with a propeller agitator, a rupture disk, a manometer, current breakage device, a temperature probe (Pt 100) and gas burette with a gas introduction tube is filled with 19.2 g of freshly distilled styrene (M=104.15 g/mol), 16.0 g 4-tert.-butylazo-4-cyano carboxylic acid of a starch hydrolysate (DS=0.02; M_{W}=25000 g/mol) und 400 g deionised water. The apparatus is subsequently rinsed-through with a low argon flow for several hours at 1° C. whilst constantly stirring. Subsequently 12.8 g of butadiene (M=54.09 g/mol) was metered to the reactor via a gas burette. The reaction mixture is heated to 70° C. and the inner temperature of the reactor is maintained under constant stirring (400 rpm). A low-viscosity polymer dispersion resulted, with a solid matter content of SMC=9.8%. The purification of the latex is effected by way of dialysis for distilled water. The hydrodynamic diameter of the styrene/butadiene particles may be determined by way of dynamic light scattering, it is 190 nm. According to the NMR analysis the particle cores consist of styrene/butadiene in the ratio of 1:1.

### EXAMPLE 7

A double casing reactor which is controlled with regard to its inner temperature and is capable of being thermostatted, with an anchor agitator, backflow cooler, temperature probe (Pt 100) and gas introduction tube is filled with 4 g of distilled styrene, 20 mg SDS (sodium dodecyl sulphate) and 40 g of deionised water. The apparatus is subsequently rinsed thoroughly with a low argon flow for several hours whilst constantly stirring, and the reaction mixture is heated to 70° C. Subsequently 2g of 4-tert.-butylazo-4-cyano carboxylic acid ester (DS=0.02; M_{W}=50000 g/mol), which was dissolved in 10 g of deionised, oxygen-free water, is added to the reactor via a septum. The reaction temperature was maintained overnight during constant stirring (400 rpm). A low-viscosity polymer dispersion with a solid-matter content SMC=10.26 resulted. The hydrodynamic diameter of the particles may be determined by way of dynamic light scattering. It is 103 nm.

The purification of the latex is effected via ultra filtration (50 nm membrane) in a Berghof cell (control of the filtrate by absorption at 258 nm).

### EXAMPLE 8

Trials with regard to the flocculation behaviour of solid matter suspended in water

In a glass cuvette (optical wavelength ˜5 cm) 300 μl of a 0.1% cationic starch graft copolymer solution (3 ppm) was metered to a kaolin solution (18 g/l, 100 ml) whilst stirring in the turbidimetric apparatus.

The stirring was interrupted after 60 s and the sedimentation of the kaolin flocs was investigated by way of turbidimetric measurement. The remaining residual turbidity is measured at 400 s.

Table 5 contains the flocculation results of the products No. 1 to 4 originating from Example 5.

TABLE 5

| | | Residual turbidity |
|---|---|---|
| No. | w [%] | [%]^{3ppm} |
| 1 | 58 | 13 |
| 2 | 48 | 17 |
| 3 | 45 | 24 |
| 4 | 32 | 30 |

1. A method for manufacturing graft copolymers with a backbone formed of at least one of starch and its derivatives, proceeding from at least one of amylose of the general formula I 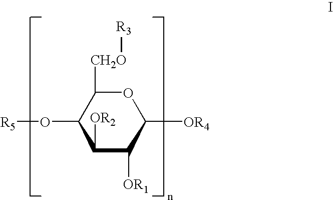
and the amylopectine deriving therefrom with
R₁ to R₅=independently of one another H, SO₃Na, PO(ONa)₂, NO₂, C(S)—SNa, alkyl or acyl with 1-20 C-atoms or aryl, which may be at least one of cationically, anionically, hydrophobically and amphiphilically substituted, wherein R₃ may also be selected in a manner such that via R₃ a linking to further glucose units is effected while forming an amylopectine and
n=300 to 60000
via the following steps:
a) conversion in the presence of an acid acceptor with a tert-alkyl azocyano carboxylic acid derivative of the general Formula II 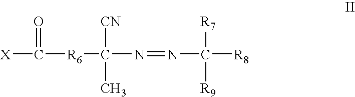
with
R₆=alkyl or carboxyalkyl with 1-20 C-atoms,
R₇, R₈, R₉=independently of one another alkyl with 1-5 C-atoms or phenyl and
X=halogen or ROO— with R=alkyl, aryl or arylalkyl.
b) addition of at least one vinyl monomer,
c) initiation of the polymerization by the formation of starch radicals via a thermal activation between 25° C. and 120° C. while separating N₂.

2. A method according to claim 1 wherein the conversion in a) is carried out in one of an aqueous solvent and an organic solvent.

3. A method according to claim 1 wherein the conversion in a) is carried out in an aqueous suspension.

4. A method according to claim 1 wherein the conversion in a) is carried out without solvent as a solid phase reaction.

5. A method according to claim 1 wherein at least one of a chloride and a mixed anhydride of succinic acid is used as a tert-alkyl azocyano carboxylic acid derivative.

6. A method according to claim 1 wherein at least partly water-soluble vinyl monomers are used in b).

7. A method according to claim 6 wherein the vinyl monomer is selected from the group consisting of acrylic acid, methacrylic acid, quaternary esters of acrylic acid, neutral esters of acrylic acid, amides of acrylic acid, quaternary esters methacrylic acid, neutral esters of methacrylic acid, amides of methacrylic acid, styrene, methyl styrene, styrene sulfonic acid, vinyl sulfonic acid, butadiene, acrylamide, N-vinyl formamide, N-methyl-N-vinyl acetamide, N-vinyl pyrrolidone, N-vinyl caprolactam, dialyl-dimethyl ammonium chloride and their mixtures.

8. A method according to claim 1 wherein the vinyl monomers are present in a concentration between 0.1 and 4.0 mol/l.

9. A method according to claim 1 wherein step b) is carried out in one of an aqueous solvent and an organic solvent.

10. A tert-alkyl azocyano carboxylic acid ester of at least one of starch and its derivatives proceeding from at least one of amylose of the general Formula III 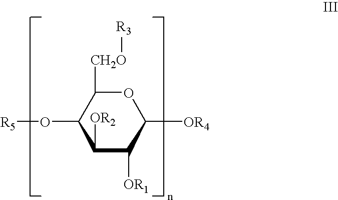
and the amylopectine deriving therefrom with
R₁ to R₅ independently of one another H, SO₃Na, PO(ONa)₂, NO₂, C(S)—SNa, alkyl or acyl with 1-20 C-atoms, which may be substituted at least one of cationically, anionically, hydrophobically and amphiphilically, wherein R₃ may also be selected in a manner such that via this a linking to further glucose units is effected via R₃ while forming an amylopectine and at least one residue R₁ to R₅ is a group of the general Formula IV 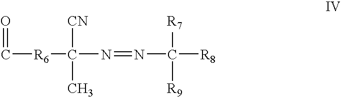
with
R₆=alkyl or carboxyalkyl with 1-20 C-atoms which may be interrupted by heteroatoms, as well as substituted,
R₇, R₈, R₉=independently of one another alkyl with 1-5 C-atoms or phenyl and
n=300 to 60000.

11. A tert-alkyl azocyano carboxylic acid ester according to claim 10, wherein the residues R₁ to R₅ independently of one another are selected from the group (alkyl) amino-alkyl, ammonium alkyl, carboxy-alkyl, alkyl, aryl, aryl-alkyl and hydroxy-alkyl.

12. A tert-alkyl azocyano carboxylic acid ester according to claim 10 wherein the molar mass of the tert-alkyl azocyano carboxylic acid ester lies between 5000 and 10000000 g/mol.

13. A tert-alkyl azocyano carboxylic acid ester according claim 10 wherein the DS-value of the residues R₁ to R₅ lies between 0.00 and 0.9 and the DS value of the group of the general Formula IV lies between 0.01 and 0.9.

14. A graft copolymer of at least one of starch and its derivatives proceeding from at least one of amylose of the general formula III 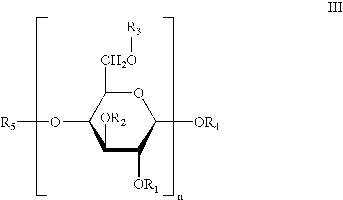
and the amylopectine deriving therefrom with
R₁ to R₅=independently of one another H, SO₃Na, PO(ONa)₂, NO₂, C(S)—SNa, alkyl or acyl with 1-20 C-atoms, which may be substituted at least one of cationically, anionically, hydrophobically and amphiphilically, and a residue of the general Formula V 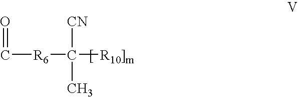
with R₆=alkyl or carboxyalkyl with 1-20 C-atoms, which may be interrupted by heteroatoms, as well as substituted,
R₁₀ a vinyl monomer with m=10-10000, wherein
R₃ may also be selected in a manner such that a linking to further glucose units is effected via R₃ while forming an amylopectine.

15. A graft copolymer according to claim 14 wherein the residues R₁ to R₅ independently of one another are selected from the group (alkyl) amino-alkyl, ammonium alkyl, carboxy-alkyl, alkyl, aryl, aryl-alkyl, hydroxy-alkyl, —CO—R and —CO—NHR, with R=alkyl, aryl and aryl-alkyl.

16. A graft copolymer according to claim 14 wherein the molar mass of the starch backbone chain is between 5000 and 10000000 g/mol.

17. A graft copolymer according to claim 14 wherein the DS value of the residues R₁ to R₅ lies between 0.00 and 0.9 and the DS-value of the group of the general Formula V lies between 0.01 und 0.9.

18. A dispersion of graft copolymers according to claim 14.

19. The use of the graft copolymers according to claim 14 as flocculants.
